(19) United States
(12) Patent Application Publication
(10) Pub. No.: US 2025/0067276 A1
(43) Pub. Date: Feb. 27, 2025

(54) FAN FOR REDUCING HIGH-FREQUENCY NOISE AND SECURING PRODUCTIVITY

(71) Applicant: Hanon Systems, Daejeon (KR)

(72) Inventors: Cheolun PARK, Daejeon (KR); Jun Ho KIM, Daejeon (KR); Ok Ryul MIN, Daejeon (KR); Dalhyun AHN, Daejeon (KR); Moon-Seok CHOI, Daejeon (KR)

(21) Appl. No.: 18/724,450

(22) PCT Filed: Nov. 18, 2022
(86) PCT No.: PCT/KR2022/018291

§ 371 Date: Jun. 26, 2024

(30) Foreign Application Priority Data
Dec. 30, 2021 (KR) 10-2021-0192412

(51) Int. Cl. F04D 29/32; F04D 29/58; F04D 29/66

(52) U.S. Cl. CPC F04D 29/329; F04D 29/5806; F04D 29/668

(57) ABSTRACT

The present invention relates to a fan capable of reducing high-frequency noise during fan operation and ensuring productivity, the fan including a fan hub open on one side, a rotor inserted and bolted to the fan hub, and a damping member disposed between the inner surface of the fan hub and the outer surface of the rotor and contacting both the fan hub and the rotor, mitigating vibration and high-frequency noise during operation.

### TECHNICAL FIELD

The present invention relates to a fan used in a vehicle, and more particularly, to a fan hub for reducing high-frequency noise and ensuring productivity.

### BACKGROUND ART

Internal combustion engines typically operate by compressing the supplied fuel and then combusting it at high temperatures and pressures. This process generates a significant amount of heat, which, if left unchecked, can cause engine components such as pistons or cylinders to overheat and malfunction. Therefore, a water jacket is typically installed around the engine's cylinders with coolant circulated through it to cool the overheated engine, but since the coolant can boil if left alone and fail to cool the engine, a radiator is installed at the front of the vehicle with a fan placed either in front of or behind the radiator to force outside air circulation, thereby cooling the heated coolant through heat exchange.

FIG. 1 illustrates a conventional fan shroud assembly 1.

The conventional fan shroud assembly 1 depicted in FIG. 1 consists of a motor 20, a fan 10 including a hub 12 connected to the drive shaft 21 of the motor 20, a plurality of blades 11 radially arranged on the periphery of the hub 12, and a fan band 13 connecting the ends of the blades 11 to prevent deformation of the blades 11, and a shroud 30 a shroud 30 having a ventilation hole 31 formed at the center thereof and a motor fixing portion 33 formed by extending radially inward from the inner surface of the ventilation hole 31 by multiple stators 32 to support and secure the motor 20.

In the conventional fan, the hub 12 and the rotor of the motor 20 are typically bolted together, but this method often leads to high-frequency noise issues due to the vibration and resonance of the rotor during fan operation.

### DISCLOSURE

### Technical Problem

The present invention has been conceived to solve the above problems and it is an object of the present invention to provide a fan capable of reducing high-frequency noise generated during operation while preventing a decrease in productivity.

### Technical Solution

In order to solve the above problems, a fan according to various embodiments of the present invention includes a fan hub open on one side, a blade formed on the outer periphery of the fan hub, a rotor inserted and coupled to the fan hub, and a damping member disposed between the inner surface of the fan hub and the outer surface of the rotor, contacting both the fan hub and the rotor.

In addition, the damping member is formed in the shape of a protrusion extending from the inner surface of the fan hub towards the rotor, reducing vibration and high frequency noise during fan operation.

In addition, the fan hub includes a bottom wall and a side wall defining the space into which the rotor is inserted, the rotor includes a bottom wall facing the bottom wall of the fan hub and a side wall facing the side wall of the fan hub, and the damping member is positioned between the bottom wall of the fan hub and the bottom wall of the rotor.

In addition, the fan hub includes a first bolt hole and a first cooling hole formed to penetrate the bottom wall thereof, the rotor includes a second bolt hole and a second cooling hole formed to penetrate the bottom wall thereof, and the damping member is positioned in a portion where the first bolting hole, the second bolting hole, the first cooling hole, and the second cooling hole are not formed, contacting both the fan hub and the rotor.

In addition, the damping member has a height equal to the gap between the bottom wall of the fan hub and the bottom wall of the rotor.

In addition, the fan hub includes a bottom wall and a side wall defining the space into which the rotor is inserted, the rotor includes a bottom wall facing the bottom wall of the fan hub and a side wall facing the side wall of the fan hub, and the damping member, based on the rotor being divided into at least two equal segments in the height direction of the rotor, is positioned at the segment corresponding to a part of the side wall closest to the bottom wall of the fan hub among the at least two segments.

In addition, the fan hub includes a plurality of ribs formed radially on the bottom wall and the side wall thereof, the damping member is positioned at the inner ends of the ribs, contacting both the ribs and the side walls of the rotor.

In addition, the damping member is positioned at the inner ends of at least three ribs.

In addition, the damping member forms an imaginary circle tangent to the damping member with a diameter smaller than or equal to the diameter of the rotor.

In addition, the damping member is positioned between the bottom wall of the fan hub and the bottom wall of the rotor, contacting both the bottom wall of the fan hub and the bottom wall of the rotor.

In addition, the damping member is formed in one or more pieces.

In addition, the damping member is formed in at least two pieces with a predetermined spacing therebetween.

### Advantageous Effects

The fan, according to various embodiments of the present invention, is advantageous in terms of reducing high-frequency noise during fan operation and ensuring productivity by utilizing a damping member that contacts the fan hub and rotor for fixing or supporting.

In addition, according to the present invention, the damping member is formed on the side of the rotor, close to the fan hub, which can reduce the possibility of misassembly and prevent a decrease in productivity.

### DESCRIPTION OF DRAWINGS

FIG. 1 is an exploded perspective view of a conventional fan shroud assembly;

FIG. 2 is an exploded perspective view of a fan for reducing high-frequency noise and ensuring productivity according to the first embodiment of the present invention;

FIG. 3 is a perspective view of a rotor;

FIG. 4 is a partial enlarged view of FIG. 2;

FIG. 5 is a cross-sectional view illustrating the fan hub 100, rotor 200, and damping member 300 of a fan for reducing high-frequency noise and ensuring productivity according to the first embodiment of the present invention;

FIG. 6 illustrates a comparison of the high-frequency noise generation during operation by a fan for reducing high-frequency noise and ensuring productivity according to the first embodiment of the present invention and a conventional fan;

FIG. 7 is a cross-sectional view of a fan for reducing high-frequency noise and ensuring productivity according to the second embodiment of the present invention;

FIG. 8 illustrates a comparison of the high-frequency noise generation during operation by a fan for reducing high-frequency noise and ensuring productivity according to the second embodiment of the present invention and a conventional fan; and

FIG. 9 is a cross-sectional view of a fan for reducing high-frequency noise and ensuring productivity according to the third embodiment of the present invention.

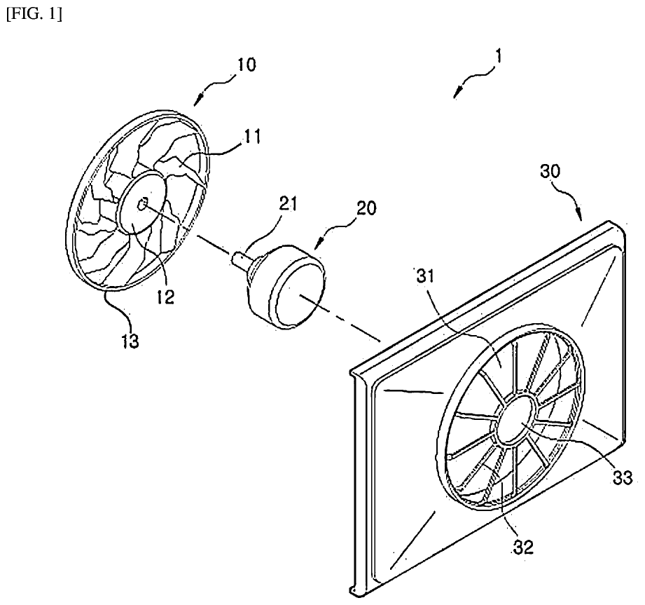

### MODE FOR INVENTION

Hereinafter, a description is made of the fan for reducing high-frequency noise and ensuring productivity according to an embodiment of the present invention with reference to the accompanying drawings.

### First Embodiment

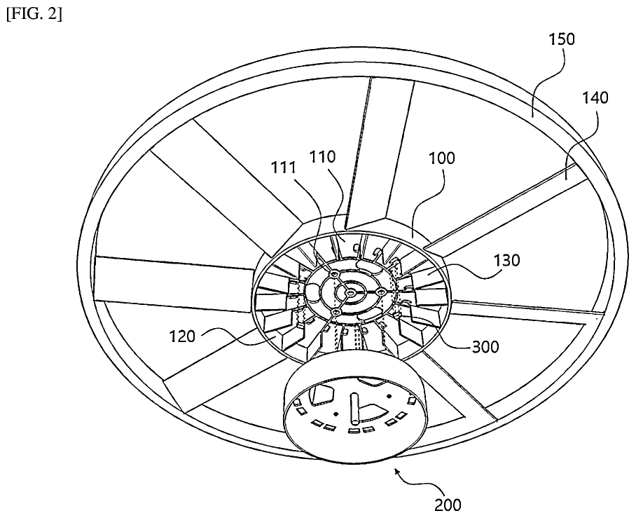

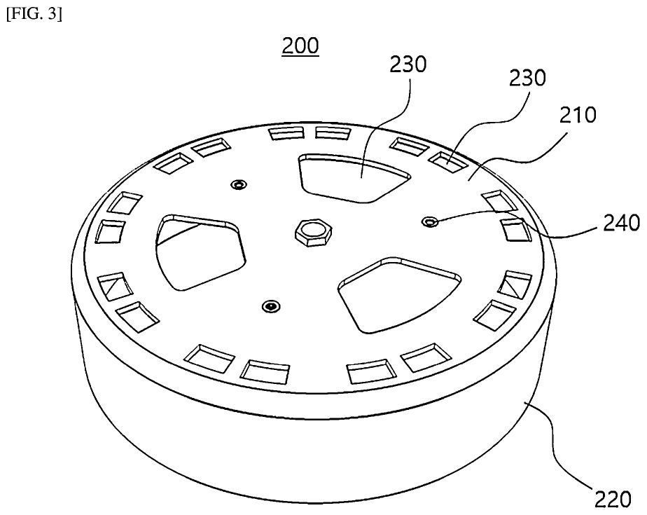

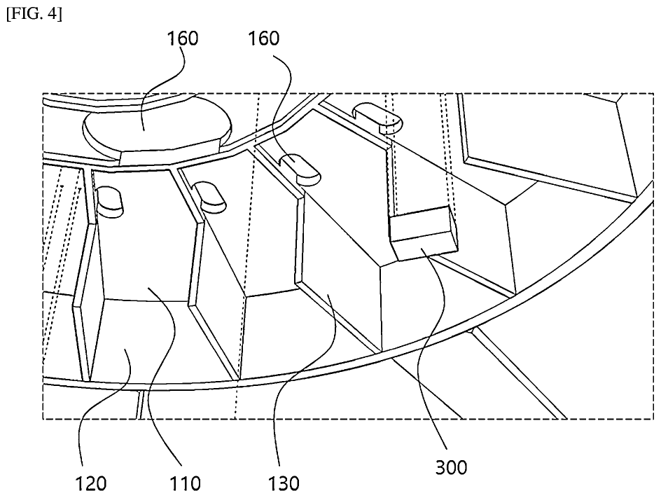

FIG. 2 is an exploded perspective view of a fan for reducing high-frequency noise and ensuring productivity according to the first embodiment of the present invention, FIG. 3 is a cross-sectional view of a rotor of the fan for reducing high-frequency noise and ensuring productivity according to the first embodiment of the present invention, and FIG. 4 is a partial enlarged view of FIG. 2.

As shown in FIGS. 2 to 4, the fan for reducing high-frequency and ensuring productivity according to the first embodiment of the present invention may include a fan hub 100, a rotor 200, damping members 300, and blades 140.

The fan hub 100 has a shape open on one side. As shown in FIG. 2, the fan hub 100 is open on the bottom side, and the rotor 200, detailed later, is inserted into this opening. The fan hub 100 includes a first bottom wall 110 and a first side wall 120 exposed through the open side, and multiple ribs 130 may be radially formed to contact the first bottom wall 110 and the first side wall 120. On the first bottom wall of the fan hub 100, first bolt holes 111 and first cooling holes 160 may be formed to penetrate. The first bolt holes 111 are for the bolted connection with the rotor 200 detailed later, and the first cooling holes 160 are formed to allow air to pass for cooling various components of the motor. The first cooling holes 160 may vary in shape and position. The blades 140 are radially formed on the outer peripheral surface of the fan hub 100, and at the end of the blades 140, a fan band 160 may be formed to prevent deformation of the blades 140.

As shown in FIGS. 2 and 3, the rotor 200 is inserted into the opening of the fan hub 100. The rotor 200 is a rotating component of the motor and is secured to the fan hub 100 via bolting. That is, the fan hub 100 rotates due to the rotation of the rotor 200. The rotor 200 includes a second bottom wall 210 and a second side wall 220, and on the second bottom wall 210, second cooling holes 230 and second bolt holes 240 may be formed.

As shown in FIGS. 2 and 4, the damping members 300 are positioned between the inner surface of the fan hub 100, referred to as the first bottom wall, and the second bottom wall 210 of the rotor 200, contacting both the fan hub 100 and the rotor 200 to mitigate vibration and high-frequency noise during operation. The damping members 300 may be formed as protrusions extending from the first bottom wall of the fan hub 100 towards the rotor 200. The damping members 300 may have a predetermined thickness. However, the present invention is not limited to the protruding shape of the protrusion 300 from the fan hub 100; there may also be embodiments where the protrusion is a separate component from the fan hub 100. In this case, the protrusion 300 may be manufactured from a rigid material such as metal or synthetic resin with a certain degree of stiffness, or from an elastic material like rubber or silicone.

In this embodiment, a total of three damping members 300 may be installed at a predetermined interval from each other. In more detail, the plurality of damping members 300 may be installed at an equal distance from the center of the fan hub 100 and may be spaced apart from each other at an equal angle. That is, the three damping members 300 may be installed at intervals of 120 degrees from each other. The angle between adjacent damping members 300 may be determined by the number of damping members 300, and the angle between adjacent damping members 300 may be the result of dividing 360 degrees by the number of damping members 300.

The thickness of the damping members 300, which is the distance from the fan hub 100 to the rotor 200, may be equal to the distance between the first bottom wall of the fan hub 100 and the second bottom wall of the rotor 200.

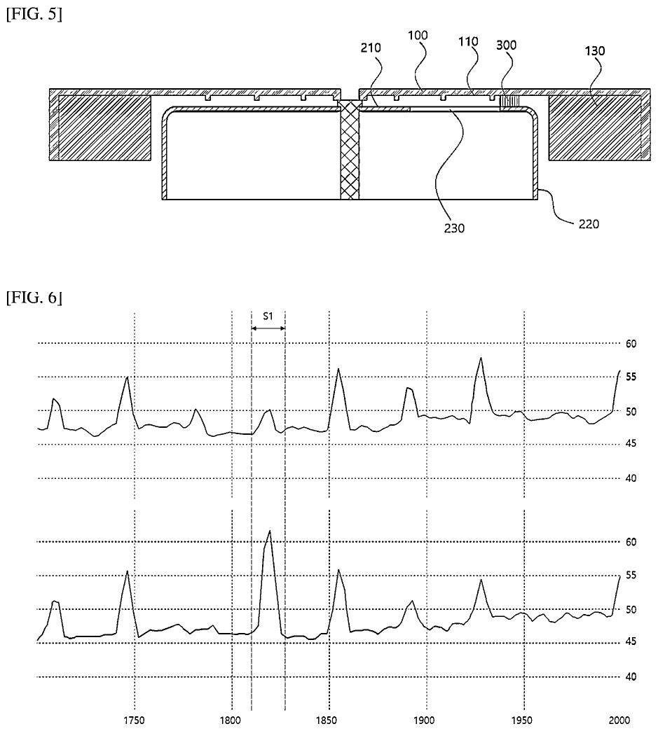

FIG. 5 is a cross-sectional view illustrating the fan hub 100, rotor 200, and damping member 300 of a fan for reducing high-frequency noise and ensuring productivity according to the first embodiment of the present invention.

As described above, the fan for reducing high-frequency noise and ensuring productivity according to the first embodiment of the present invention includes three damping members 300, and only a single damping member 300 is depicted in the cross-sectional view of FIG. 5. The damping member 300 contacts at the top surface thereof with the first bottom wall 110 of the fan hub 100 and at the bottom surface thereof with the second bottom wall 210 of the rotor 200, thereby securing or supporting the fan hub 100 and rotor 200 beyond bolts (not shown) to reduce high-frequency noise and vibration during fan operation.

The first bolt holes 111 and the first cooling holes 160 formed in the fan hub 100, and the second bolt holes 240 and the second cooling holes 230 formed in the rotor 200 may be aligned with each other, respectively. That is, when the fan hub 100 and the rotor 200 are coupled together, the first bolt holes 111, the first cooling holes 160, the second bolt holes 240, and the second cooling holes 230 may be aligned with each other, respectively, and may be located in the same position. The damping member 300 is positioned between the fan hub 100 and the rotor 200, located in areas where bolt holes and cooling holes are not formed, thereby fastening between the fan hub 100 and the rotor 200 without compromising cooling performance.

FIG. 6 illustrates a comparison of the high-frequency noise generation during operation by a fan for reducing high-frequency noise and ensuring productivity according to the first embodiment of the present invention and a conventional fan, with the graph at the bottom showing the generation of high-frequency noise during operation for the conventional fan, and the graph at the top showing the generation of high-frequency noise during operation for the fan according to this embodiment.

As shown in FIG. 6, in section S1 (frequency range), the fan for reducing high-frequency noise and ensuring productivity according to the first embodiment of the present invention generates 50 dB of noise during operation, while the conventional fan generates 62 dB of noise, demonstrating a noise reduction effect of approximately 12 dB.

### Second Embodiment, Third Embodiment

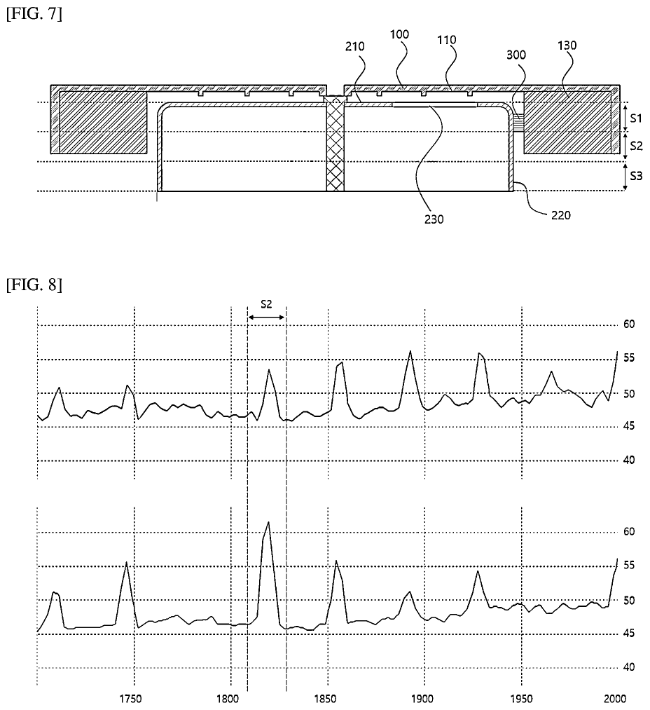

FIG. 7 is a cross-sectional view of a fan for reducing high-frequency noise and ensuring productivity according to the second embodiment of the present invention.

The fan for reducing high-frequency noise and ensuring productivity according to the second embodiment of the present invention is the same as the fan for reducing high-frequency noise and ensuring productivity according to the first embodiment of the present invention described above, except for the difference in the position of the damping member 300.

In the embodiment of FIG. 7, the damping member 300 is positioned between the rib 130 of the fan hub 100 and the second side wall 220 of the rotor 200, contacting both the fan hub 100 and the rotor 200 to secure or supports the fan hub 100 and rotor 200, enabling high-frequency reduction during operation, similar to the fan for reducing high-frequency noise and ensuring productivity according to the first embodiment of the present invention described above.

When the damping member 300 is positioned between the rib 130 of the fan hub 100 and the second side wall 220 of the rotor 200 to secure or support the fan hub 100 and the rotor 200, the location of the damping member 300 may be in the part closest to the fan rib 130, which is segment S1, when the rotor 200 is divided into three equal segments, S1, S2, and S3 in the height direction of the rotor 200. The reason for this is that when being formed in other segments, S2 or S3, the damping member 300 may be farther from the part where the fan hub 100 and rib 130 are bolted together, increasing the risk of misalignment during fan hub 100 and rotor 200 assembly. In contrast, when the damping member 300 is positioned in segment S1, the part where the fan hub 100 and the rib 130 are bolted together is closer to the damping member 300, reducing the likelihood of misassembly. Consequently, no reduction in productivity occurs.

As shown in FIG. 7, when being positioned between the rib 130 of the fan hub 100 and the second side wall 220 of the rotor 200, the damping member 300 may either be formed in a protruding shape extending from the end of the rib 130 towards the rotor 200, or the damping member 300 may be manufactured a separate component and adhered or attached to the end of the rib 130. The damping members 300 may also be arranged at least three or more at regular intervals (or at a predetermined angle) to contact the second side wall 220 of the rotor 200, aiming to provide more stable support to the rotor 200 and reduce high-frequency noise during the operation of the fan. For this purpose, the diameter of the imaginary circle tangent to three or more damping members 300 may be equal to or smaller than the diameter (outer diameter) of the rotor 200.

FIG. 8 illustrates comparison of the high-frequency noise generation during operation by a fan for reducing high-frequency noise and ensuring productivity according to the second embodiment of the present invention and a conventional fan, with the graph at the bottom showing the high-frequency noise generation during operation for the conventional fan, and the graph at the top showing the high-frequency noise generation during operation for the fan according to this embodiment.

As shown in FIG. 8, in section S2, the fan for reducing high-frequency noise and ensuring productivity according to the second embodiment of the present invention generates 54 dB of noise during operation, while the conventional fan generates 62 dB of noise, demonstrating a noise reduction effect of approximately 8 dB.

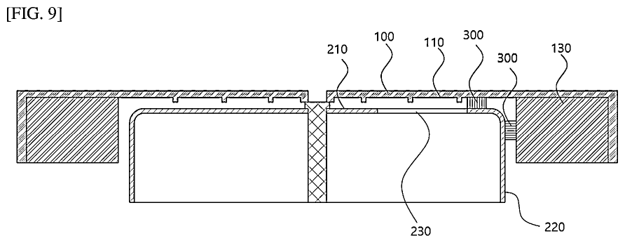

FIG. 9 is a cross-sectional view of a fan for reducing high-frequency noise and ensuring productivity according to the third embodiment of the present invention.

As shown in FIG. 9, the fan for reducing high-frequency noise and ensuring productivity according to the third embodiment of the present invention may have the damping members 300 positioned simultaneously between the first bottom wall 110 of the fan hub 100 and the second bottom wall 210 of the rotor 200, and between the second side wall 220 of the rotor 200 and the rib 130. That is, the damping member 300 according to this embodiment possess all the features of the fans for reducing high-frequency noise and ensuring productivity described in the first and second embodiments of the present invention.

The present invention is not limited to the above-described embodiments, and it is obvious that various modifications can be made without departing from the essence of the present invention claimed.

### DESCRIPTION OF REFERENCE NUMERALS

100: fan hub
110: first bottom wall
111: first bolt hole
120: first side wall
130: rib
140: blade
150: fan band
160: first cooling hole
200: rotor
210: second bottom wall
220: second side wall
230: second cooling hole
240: second bolt hole
300: damping member

1. A fan comprising:
a fan hub open on one side;
a blade formed on the outer periphery of the fan hub;
a rotor inserted and coupled to the fan hub; and
a damping member disposed between the inner surface of the fan hub and the outer surface of the rotor, contacting both the fan hub and the rotor.

2. The fan of claim 1, wherein the damping member is formed in the shape of a protrusion extending from the inner surface of the fan hub towards the rotor, reducing vibration and high frequency noise during fan operation.

3. The fan of claim 2, wherein the fan hub comprises a bottom wall and a side wall defining the space into which the rotor is inserted, the rotor comprises a bottom wall facing the bottom wall of the fan hub and a side wall facing the side wall of the fan hub, and the damping member is positioned between the bottom wall of the fan hub and the bottom wall of the rotor.

4. The fan of claim 3, wherein the fan hub comprises a first bolt hole and a first cooling hole formed to penetrate the bottom wall thereof, the rotor comprises a second bolt hole and a second cooling hole formed to penetrate the bottom wall thereof, and the damping member is positioned in a portion where the first bolting hole, the second bolting hole, the first cooling hole, and the second cooling hole are not formed, contacting both the fan hub and the rotor.

5. The fan of claim 3, wherein the damping member has a height equal to the gap between the bottom wall of the fan hub and the bottom wall of the rotor.

6. The fan of claim 1, wherein the fan hub comprises a bottom wall and a side wall defining the space into which the rotor is inserted, the rotor comprises a bottom wall facing the bottom wall of the fan hub and a side wall facing the side wall of the fan hub, and the damping member, based on the rotor being divided into at least two equal segments in the height direction of the rotor, is positioned at the segment corresponding to a part of the side wall closest to the bottom wall of the fan hub among the at least two segments.

7. The fan of claim 6, wherein the fan hub comprises a plurality of ribs formed radially on the bottom wall and the side wall thereof, the damping member is positioned at the inner ends of the ribs, contacting both the ribs and the side walls of the rotor.

8. The fan of claim 7, wherein the damping member is positioned at the inner ends of at least three ribs.

9. The fan of claim 8, wherein the damping member forms an imaginary circle tangent to the damping member with a diameter smaller than or equal to the diameter of the rotor.

10. The fan of claim 7, wherein the damping member is positioned between the bottom wall of the fan hub and the bottom wall of the rotor, contacting both the bottom wall of the fan hub and the bottom wall of the rotor.

11. The fan of claim 1, wherein the damping member is formed in one or more pieces.

12. The fan of claim 11, wherein the damping member is formed in at least two pieces with a predetermined spacing therebetween.
